(19) United States
(12) Patent Application Publication
(10) Pub. No.: US 2025/0099787 A1
(43) Pub. Date: Mar. 27, 2025

(54) IMPROVED RESCUE BREATHER

(71) Applicant: CSE CORPORATION, Export, PA (US)

(72) Inventors: Nick G. Manis, Export, PA (US); Scott A. Shearer, Sr., Export, PA (US); Eugene Gutierrez, Export, PA (US); Sean A. Tremba, Export, PA (US)

(73) Assignee: CSE CORPORATION, Export, PA (US)

(21) Appl. No.: 18/727,265

(22) PCT Filed: Jan. 9, 2023
(86) PCT No.: PCT/US2023/010435

§ 371 Date: Jul. 8, 2024

Related U.S. Application Data
(60) Provisional application No. 63/297,576, filed on Jan. 7, 2022.

(51) Int. Cl. A62B 7/08; A62B 7/12

(52) U.S. Cl. CPC A62B 7/08; A62B 7/12

(57) ABSTRACT

A rescue breather used by workers as an oxygen source in the event of an emergency. The rescue breather comprises cannisters containing a chemical scrubber, where the scrubber is contained within the cannister with a cartridge assembly. The cartridge assembly distributes air throughout the chemical scrubber. A manifold can be used to distribute air across a rescue breather having a plurality of cannisters. A heat exchanger is positioned within the manifold and above the cannisters.

### CROSS-REFERENCE TO RELATED APPLICATIONS

This application claims the benefit under 35 U.S.C. § 119 of U.S. Provisional Application Ser. No. 63/297,576, filed Jan. 7, 2022, which is incorporated herein by reference.

### STATEMENT REGARDING FEDERALLY SPONSORED RESEARCH

Not applicable.

### BACKGROUND OF THE INVENTION

The invention relates generally to a rescue breather. More specifically, the invention relates to a rescue breather having a cartridge assembly that provides extended usage times, smaller size, and increased efficiency.

Rescue breathers, also known as self-contained self-rescuers, are utilized by miners, underground construction crews, and other workers in hazardous environments as an oxygen source in the event of an emergency. As a critical piece of safety equipment, each worker carries a rescue breather throughout their shift, necessitating a compact, rugged device that can be deployed as a source of oxygen in an emergency. To satisfy these operational requirements, a rescue breather recycles the air exhaled by a user by scrubbing carbon dioxide from the exhaled air using chemicals, such as potassium superoxide. By recycling the air, a rescue breather has a more compact size compared to tank-based breathing system.

Due to the small size, rescue breathers typically provide oxygen to the user for a limited duration. The duration of operative use is limited by the consumption of potassium superoxide or other chemicals used in the rescue breather. However, due to the compact size and constrained air flow through the device, many rescue breathers fail to utilize the entirety of the potassium superoxide contained within the device. As a result, the rescue breather must contain more potassium superoxide than would otherwise be necessary to ensure an adequate operational duration. In addition, the resistance to air flow experienced by a user increases steadily as the device is used and the chemical scrubbers are utilized. For example, a rescue breather with a resistance of 0.7 KPa at deployment may have a resistance of 1.3 KPA after 60 minutes of use. An increase in resistance may also result from heat exchangers necessary to lower the temperature of scrubbed air. The heat exchangers are typically positioned on the breathing hose and are a source of air resistance at the beginning of the air path. Discomfort is experienced by the user, who may struggle to breath using a device with high air flow resistance, leading the user to exchange the rescue breather for a fresh unit. Therefore, it would be advantageous to develop a rescue breather with improved air flow and utilization of scrubber chemicals.

### BRIEF SUMMARY

One embodiment of the present invention is a rescue breather having dual canisters and a manifold that improves the distribution of gases across the chemical scrubber. In addition, the rescue breather of the present disclosure comprises a cartridge assembly to hold the scrubber chemical and aid the distribution of gases through the chemical scrubbers. A heat exchanger integrated into the manifold assembly minimizes the amount of air resistance experienced by the user compared to heat exchangers positioned on or near the breathing hose.

### BRIEF DESCRIPTION OF THE SEVERAL VIEWS OF THE DRAWINGS

FIG. 1 is a drawing of the exterior of a rescue breather, according to one embodiment.

FIG. 2 is a rescue breather with the external case removed and a breathing hose extended.

FIGS. 3A-3C are views of a manifold.

FIG. 4 shows dual canisters forming part of the rebreather.

FIG. 5 shows the internal components of a canister.

FIG. 6 is a cross-sectional view of a rescue breather.

FIGS. 7A-7B are views showing a heat exchanger.

### DETAILED DESCRIPTION

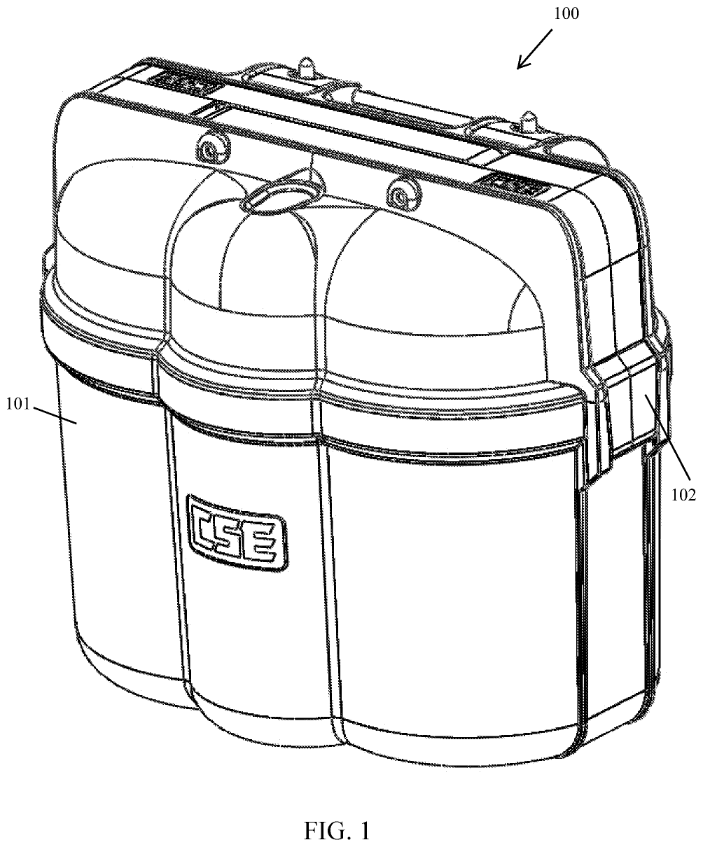

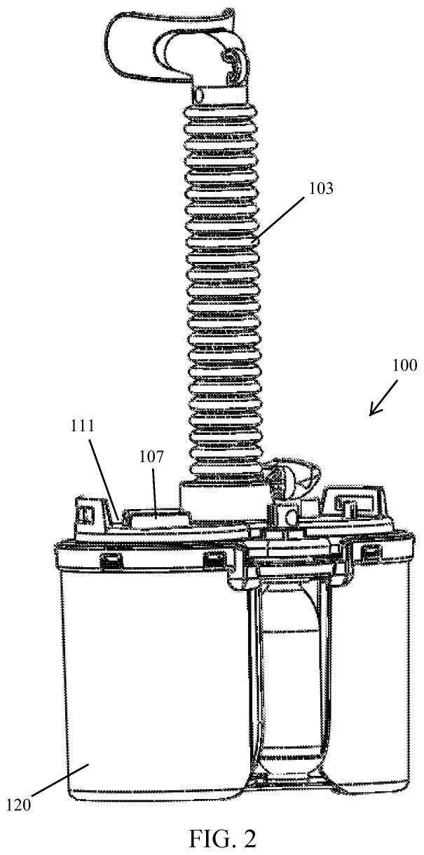

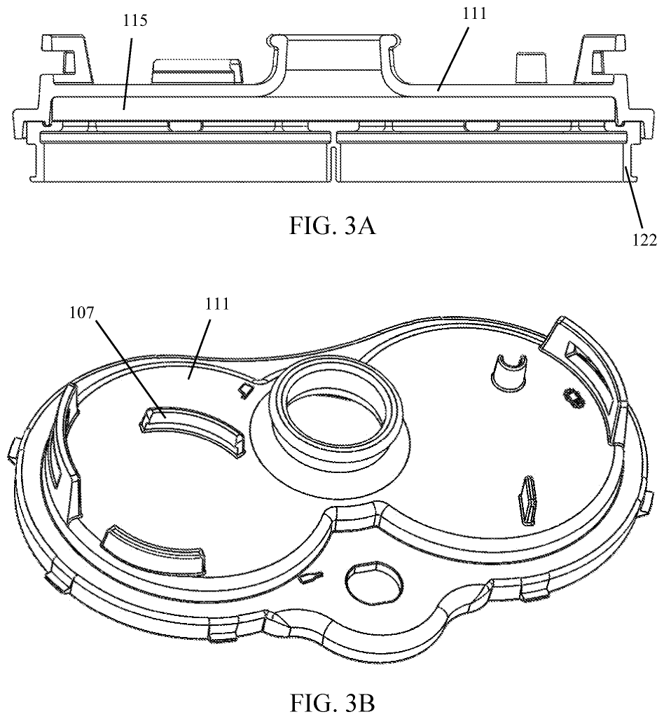

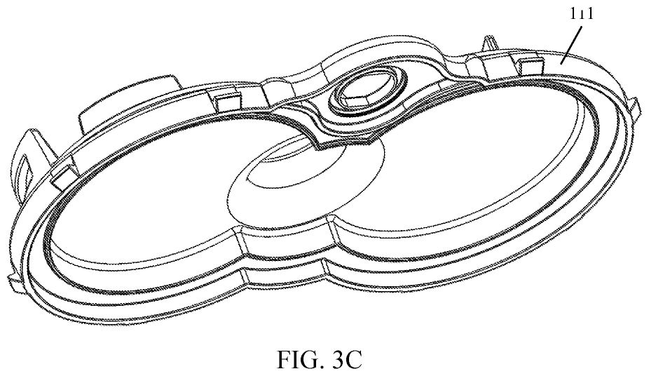

In one example embodiment, as shown in FIG. 1, the rescue breather 100 comprises a housing 101 and may include a strap attachment and locking clip 102. The housing 101 may comprise two parts and the locking clip 102 maintains the two parts in sealed engagement. The rescue breather 100 is sealed to prevent depletion of the chemical scrubber 105 when stored. In one embodiment, the housing 101 is constructed from a polymer material, which permits a more consistent seal compared to metallic housings. In the event of an emergency, a user would remove the locking clip 102 to access the internal components of the breather 100 and initiate airflow through the device 100. The locking clip 102 can include an anti-tampering feature which prevents the clip 102 from being re-installed after being unlocked. This prevents a housing with a broken seal from being reused, preventing a user from attempting to use a rebreather 100 with spent chemicals 105. In some embodiments, the housing 101 may include an optional moisture indicator and heat indicator to warn the user of exposure to environments that could degrade the performance of the rescue breather 100. For example, a rescue breather 100 left in a hot vehicle can experience temperatures that degrade the chemical scrubber 105, making it unsuitable for use in an emergency. In one embodiment, within the housing 101 is a storage platform 107 for a breathing hose 103, nose clamp, breathing bag, googles, and starter tag. The storage platform 107 may comprise clips that are incorporated or integrated into the top of the manifold 111, as shown in FIGS. 2 and 3A. In alternative embodiments, the rescue breather 100 may contain additional features, such as tamper-proof pins and a quick-removal retainer.

When deployed, a user will open the housing 101 and place the breathing hose 103 in their mouth. Exhaled air enters the breathing hose 103 and passes through the device 100 before being captured by a breathing bag (not shown). A nose clamp can be used to ensure all air exhaled and inhaled by the user will be through the rebreather 100 via the breathing hose 103. As the exhaled air passes through the device 100, the air contacts a chemical scrubber 105 which may be contained in more than one cannister 110. The chemical scrubber 105 may comprise potassium superoxide or any other chemical with the ability to release oxygen and/or remove carbon dioxide from air. In one embodiment, the breathing bag is welded to an exterior surface of the manifold 111, which may provide a more secure connection than a mechanical connection.

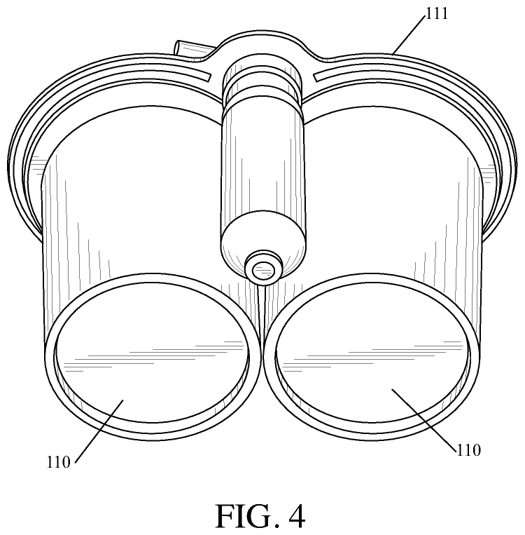

FIG. 4 shows an embodiment of the rescue breather 100 having dual canisters 110. Prior art rescue breathers typically used a single canister design, which requires larger dimensions to contain an adequate supply of scrubber chemicals. The drawback of a larger single canister is a greater pressure drop as the air passes through the tall column of scrubber chemicals. In addition, a cannister with larger dimensions may not allow exhaled air exiting the breathing hose from reaching the scrubber chemicals at the perimeter of the cannister. With a dual canister design, the rescue breather 100 of the present disclosure reduces the pressure differential experienced by a user and more effectively utilizes the chemical scrubber 105 within the cannisters 110.

To provide adequate airflow through each canister 110 in the dual canister embodiment, a manifold 111 is provided to distribute the exhaled air exiting the breathing hose 103. As shown in FIG. 4, the manifold 111 distributes the air exhaled by a user to the top surface of each canister 110. FIGS. 3A-3C show additional details of the manifold 111, with FIG. 3A showing a cross-sectional view of the manifold 111, FIG. 3B showing a top-side view of the manifold 111, and FIG. 3C showing a bottom-side view of the manifold 111. As shown in these drawings, the manifold 111 includes an inlet that connects to the breathing hose 103.

Further shown in FIG. 3A is a heat exchanger disposed between the inlet connected to the breather hose 103 and the top of the cannisters 110. In the embodiment shown in FIG. 3A, the heat exchanger 115 spans the width of the manifold 111. In this design, the heat exchanger 115 is positioned closer to the heat source (i.e. scrubber chemicals 105) than if it were placed at the top of the breather hose 103, near the mouth piece. In addition, unlike prior heat exchangers incorporated into the breathing hose, the heat exchanger 115 of the embodiment shown in FIG. 3A has a significantly larger mass, improving performance.

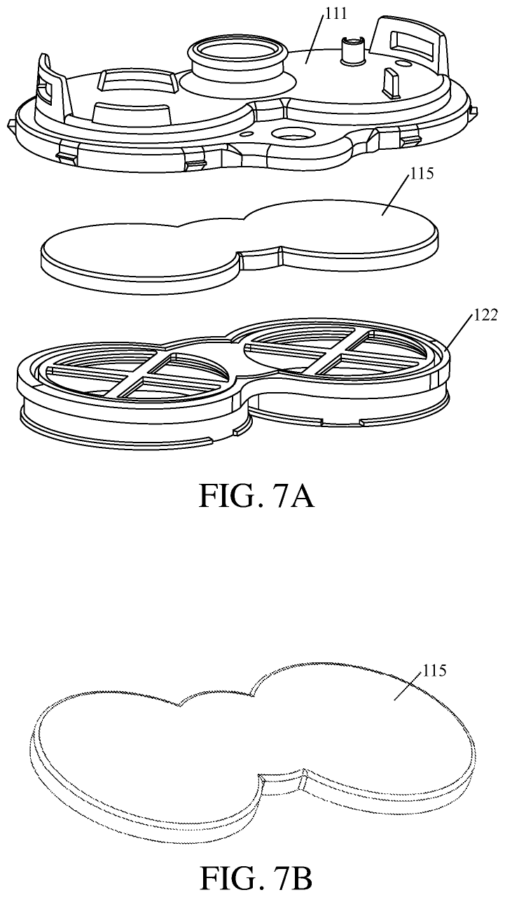

Referring again to FIG. 3A, the heat exchanger 115 is pressed into a recess of the manifold 111 to maintain a specific density and shape of the heat exchanger 115 material, ensuring proper performance with respect to resistance and heat exchange. In one embodiment, the heat exchanger 115 is made of copper, but other materials such as aluminum, stainless steel, alloys, and other metallic and non-metallic materials can be used. FIGS. 7A and 7B show a more detailed view of the heat exchanger 115 and how it integrates with the manifold 111. The heat exchanger may comprise an oriented layer of copper filaments. In another embodiment, the heat exchanger material resembles a structured sponge. These design permit decreased air resistance compared to designs which include strands of material that are oriented in a random, balled-up configuration, which are typical in many rescue breathers. Another benefit of incorporating the heat exchanger 115 into the manifold 111 is that additional joints, or leak points, are eliminated. The rescue breathers 100 are often used in extreme environments by users who are experiencing an emergency. Preventing failure points, such as a connection between the breather hose 103 and heat exchanger 115, can further limit safety risks experienced by the user.

During operation, as the air passes through the chemical scrubber 105, which is often in the form of small, solid granules, carbon dioxide is removed from the air and oxygen is released. In one embodiment, the chemical scrubber 105 comprises potassium superoxide. In an alternative embodiment, the chemical scrubber 105 comprises a layer of potassium superoxide and a layer of lithium hydroxide. After contacting the scrubber 105, the exhaled air (now partially scrubbed) enters the breathing bag. When a user inhales, the air from the breathing bag is drawn through the chemical scrubber 105 a second time, enters the breathing hose 103 via the manifold 111, and enters the user's lungs. When used in this manner, a rescue breather can typically provide 45 minutes of use at up to 1.35 L of oxygen per minute.

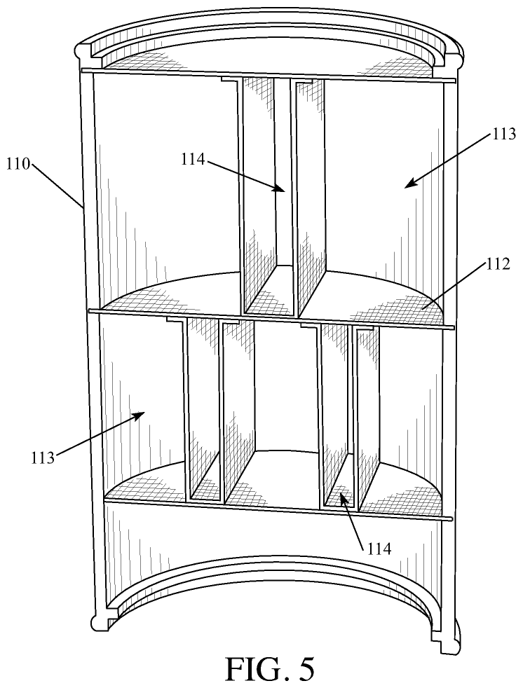

The size of the granules of chemical scrubber 105, the packing density, and the cannister 110 size are factors affecting the flowrate through the rescue breather 100. If the flowrate is too low, the user will experience breathing resistance and difficulty taking breaths. Conversely, a high flowrate will reduce breathing resistance, but may not permit sufficient time for carbon dioxide to be removed from the exhaled air as the contact time between the air and scrubber 105 is too low. The rescue breather 100 of the present disclosure utilizes a cartridge assembly 112 within the cannister 110 to direct airflow through the scrubber chemical 105, ensuring adequate contact between the chemical scrubber 105 and exhaled air. FIG. 5 shows the cartridge assembly 112, according to one embodiment.

As shown in FIG. 5, the cartridge assembly 112 comprises multiple screens separating the chemical scrubber 105 from open space within the cannister 110. In this configuration, the cartridge assembly 112 retains the chemical scrubber 105 within the cannister 110 while promoting airflow through several sections of the cannister 110. For example, as shown in FIG. 4, air entering the cannister 110 will pass through a first section near the top of the cannister 110, where the first section includes chemicals 105 positioned in filled cavities 113 on each side of an open cavity 114 located at the center of the cannister 110. Some air will pass through the chemicals 105 in this first section, while the remainder of the air will pass through the open cavity 114. A second section or layer of the cannister 110 is situated below the first section in the path of airflow. The second section contains two open cavities 114 interspersed by three chemical-filled cavities 113. The open cavity 114 of the first section is directly inline (along the airflow path) with the center chemical-filled cavity 113 of the second section. By providing open sections 114, airflow is distributed more evenly through the chemical scrubber 105. With thorough distribution through the cannister 110, the chemical scrubber 105 is more effectively utilized, reducing air resistance and extending the operational time of the rescue breather 100. In one embodiment, the efficiency of carbon dioxide removal improved to nearly 97%, whereas single canister designs without a cartridge assembly offer less than 80% efficiency. In prior art systems, the screens were used simply to keep the chemical retained within the cannister, but did not significantly affect airflow. A person having skill in the art will appreciate that other cartridge assembly 112 configurations can be utilized to promote airflow across the chemical scrubber 105. An additional benefit of using a cartridge assembly 112 is a more consistent manufacturing process, leading to similar performance across multiple units of the rebreather 100.

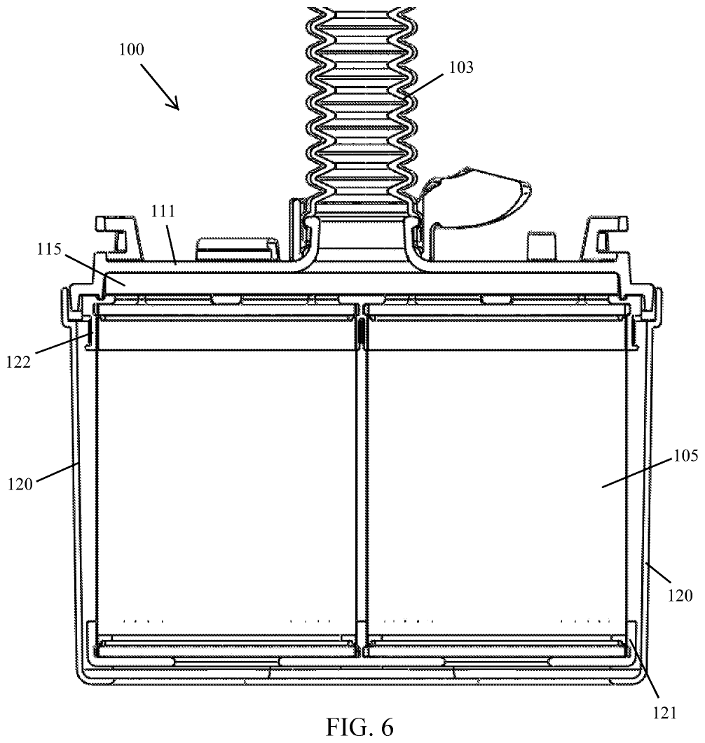

The heat exchanger 115 can be built within the housing 101, the manifold 111, or the hose 103 and is used to lower the temperature of the air entering the user's lungs, as the chemical removal process is typically exothermic. FIG. 6 shows a cross-sectional view of the device 100, with the heat exchanger 115 located within the manifold 111. FIG. 6 also shows a mouthpiece retained on the storage platform 107 disposed on the top of the manifold 111. FIG. 6 further shows a heat shield 120 positioned near an exterior of the canisters 110 to prevent the user from contacting the elevated temperatures associated with the cannisters 110 during use. The heat shield 120 creates an air gap between the cannisters 110 and the exterior of the device 100. In some embodiments, the heat shield 120 clips to a top collar 122, keeping the components of the rescue breather 100 in the proper orientation. The top collar 122 may be a separate component, as shown in FIG. 7A, or it may be integrated into the manifold 111. In one embodiment, the top collar 122 is adapted to fit into a recess within the manifold and is further branded, or sealed, to the top surface of the cannisters 110, creating an airtight seal between the cannisters 110 and the top collar 122. The heat shield 120 may also include a bottom collar 121 that keeps the bottoms of the cannisters 110 separated.

When used in this specification and claims, the terms “comprises” and “comprising” and variations thereof mean that the specified features, steps, or integers are included. The terms are not to be interpreted to exclude the presence of other features, steps, or components.

The invention may also broadly consist in the parts, elements, steps, examples, and/or features referred to or indicated in the specification individually or collectively in any and all combinations of two or more said parts, elements, steps, examples, and/or features. In particular, one or more features in any of the embodiments described herein may be combined with one or more features from any other embodiment(s) described herein.

Protection may also be sought for any features disclosed in any one or more published documents referred to and/or incorporated by reference in combination with the present disclosure. Although certain example embodiments of the invention have been described, the scope of the amended claims is not intended to be limited solely to these embodiments. The claims are to be construed literally, purposively, and/or to encompass equivalents.

What is claimed is:

1. A rescue breather comprising:
at lease two cannisters containing a chemical capable of scrubbing carbon dioxide from air;
a cartridge assembly for retaining the chemical scrubber within each cannister of the at least two cannisters,
wherein the cartridge assembly comprises a plurality of open cavities interspersed between scrubber-filed cavities;
a manifold positioned adjacent to the at least two cannisters,
wherein the manifold distributes air into the at least two cannisters; and
a heat exchanger disposed between the manifold and a top surface of the at least two cannisters.

2. The rescue breather of claim 1, further comprising:
a breathing hose attached to the manifold,
wherein the manifold receives air from the breathing hose.

3. The rescue breather of claim 1, further comprising:
a housing surrounding the at least one cannister,
wherein the housing comprises two parts held in sealable engagement by a retaining clip.

4. The rescue breather of claim 1, wherein the cartridge assembly contains at least two levels of open cavities positioned adjacent to scrubber-filled cavities.

5. The rescue breather of claim 1, wherein the heat exchanger comprises an oriented layer of metallic filaments.

6. The rescue breather of claim 1, wherein the heat exchanger spans a width of the manifold.

7. The rescue breather of claim 1, further comprising:
a heat shield located adjacent to the at least two cannisters.

8. The rescue breather of claim 7, wherein the heat shield creates an air gap between an inner surface of the heat shield and an exterior surface of the at least two cannisters.

9. The rescue breather of claim 7, further comprising:
an attachment mechanism to seal the heat shield to the manifold.

10. The rescue breather of claim 1, further comprising:
a top collar, wherein the top collar is adapted to fit into a recess in the manifold.

11. The rescue breather of claim 10, wherein the top collar is branded to the at least two cannisters forming an air tight seal.
